(19) United States
(12) Patent Application Publication
(10) Pub. No.: US 2010/0155426 A1
(43) Pub. Date: Jun. 24, 2010

(54) Toilet detergent dispenser

(76) Inventor: Johnson J.Y. Hsu, Taichung County (TW)

Correspondence Address: BACON & THOMAS, PLLC, 625 SLATERS LANE, FOURTH FLOOR, ALEXANDRIA, VA, 22314-1176, US

(21) Appl. No.: 12/385,172

(22) Filed: Apr. 1, 2009

(30) Foreign Application Priority Data
Dec. 22, 2008 (TW) 97150149

(51) Int. Cl. B67D 5/06; B67D 5/00

(52) U.S. Cl. 222/180; 222/630

(57) ABSTRACT

A toilet detergent dispenser includes a housing, a spacer, a sealing member, and a flow leader. The housing having a chamber. The spacer partitions the chamber into a water entrance and a water exit. The water entrance is located above the water exit. The sealing member is tightly covered on a top end of the spacer and the housing to seal the chamber in such a way that the water entrance and the water exit are independently sealed. The flow leader communicates with the water entrance and the water exit, extending into the water exit from the water entrance and having a bottom end spaced from a bottom edge of the water exit. Accordingly, the water is equably mixed with the toilet detergent in the water exit to become a saturated solution beforehand and then dispensed in fixed amount.

### BACKGROUND OF THE INVENTION

1. Field of the Invention

The present invention relates generally to sanitary ware, and more particularly, to a toilet detergent dispenser.

2. Description of the Related Art

A conventional toilet detergent is usually solid and when it is used, it is put into the toilet tank and then the water containing the detergent is flushed into the toilet after the detergent is dissolved in the water. After put into the toilet tank, the conventional toilet detergent keeps dissolution till it is fully dissolved, and the time of the dissolution is not adjustable as per the time interval or number of the flush, such that the detergent is subject to excessively dense or dilute in the water. For example, if the toilet is flushed repeatedly in a short time, the detergent in the water will become excessively dilute; if the toilet is not flushed for a longer time, the detergent in the water will become excessively dense.

Taiwan Patent No. 142054 disclosed a toilet detergent dispenser for improvement of the above drawback. The toilet detergent dispenser includes a housing having a plurality of inlets formed on a top end thereof and a plurality of outlets located below the inlets, wherein a toilet detergent dispenser is put inside the housing. When the toilet detergent dispenser is placed in the toilet tank, the water in the toilet tank can enter the housing through the inlets and exit the housing through the outlets. However, the inlets and the outlets are too much close to each other. Besides, the solution of the water and the detergent at the upper part of the housing reaches the saturation at a very slow pace, and none of any design of equably mixing the water and the toilet detergent is available; in fact, the water infused through the inlets is only mixed with a little of the detergent and then exhausts through the outlets, such that the concentration of the detergent in the water is usually insufficient.

China Patent No. 2098526 disclosed another toilet detergent dispenser for improvement of the drawback that the above-mentioned toilet detergent dispenser failed to dispense the toilet detergent in fixed amount. This toilet detergent dispenser includes a can body having inlets formed on its lid and outlets formed on its lateral side. Because a quantifying member is mounted to the bottom side of the lid of the can body, the toilet detergent can be dispensed in fixed amount by the quantifying member. However, the inlets and outlets are located on the can body and are in communication with one other, such that the water in the toilet tank can directly enter the can body through the inlets and exhaust through the outlets rather than the quantifying member. In this way, the detergent located at the bottom side of the can body exhausts through the outlets without being definitely mixed with the water, such that the concentration of the detergent in the water is usually insufficient either.

### SUMMARY OF THE INVENTION

The primary objective of the present invention is to provide a toilet detergent dispenser, which can dispense the toilet detergent in fixed amount for equable concentration of the detergent in the water.

The foregoing objective of the present invention is attained by the toilet detergent dispenser composed of a housing, a spacer, a sealing member, and a flow leader. The housing includes a chamber. The spacer partitions the chamber into a water entrance and a water exit. The water entrance is located above the water exit. The water entrance has at least one inlet running through the housing. The water exit has at least one outlet running through the housing. The sealing member is tightly covered on a top end of the spacer and the housing to seal the chamber in such a way that the water entrance and the water exit are independently sealed. The flow leader communicates with the water entrance and the water exit, extending into the water exit from the water entrance and having a bottom end spaced from a bottom edge of the water exit.

In light of the above structure, the toilet detergent and the water are mixed to become a saturated solution in the water exit beforehand and when the user flushes the toilet, the saturated solution is dispensed in equable concentration and fixed amount through the outlets. In this way, the insufficient concentration of the toilet detergent in the toilet tank is avoided and the consumption of the toilet detergent is saved; meanwhile, the toilet detergent can be used for a longer time for the cleaning purpose.

### BRIEF DESCRIPTION OF THE DRAWINGS

FIG. 1 is an exploded view of a part of a first preferred embodiment of the present invention.

FIG. 2 is a perspective view of the first preferred embodiment of the present invention.

FIG. 3 is a schematic view of the first preferred embodiment of the present invention mounted inside the toilet tank full of the water.

FIG. 4 is similar to FIG. 3, illustrating that some of the water remains in the toilet tank.

FIG. 5 is an exploded view of a part of a second preferred embodiment of the present invention.

FIG. 6 is a perspective view of the second preferred embodiment of the present invention.

FIG. 7 is an exploded view of a part of a third preferred embodiment of the present invention.

FIG. 8 is a perspective view of the third preferred embodiment of the present invention.

FIG. 9 is another perspective view of the third preferred embodiment of the present invention.

FIG. 10 is an internal view of a part of the third preferred embodiment of the present invention.

FIG. 11 is a sectional view taken along a line 11-11 indicated in FIG. 10.

### DETAILED DESCRIPTION OF PREFERRED EMBODIMENTS

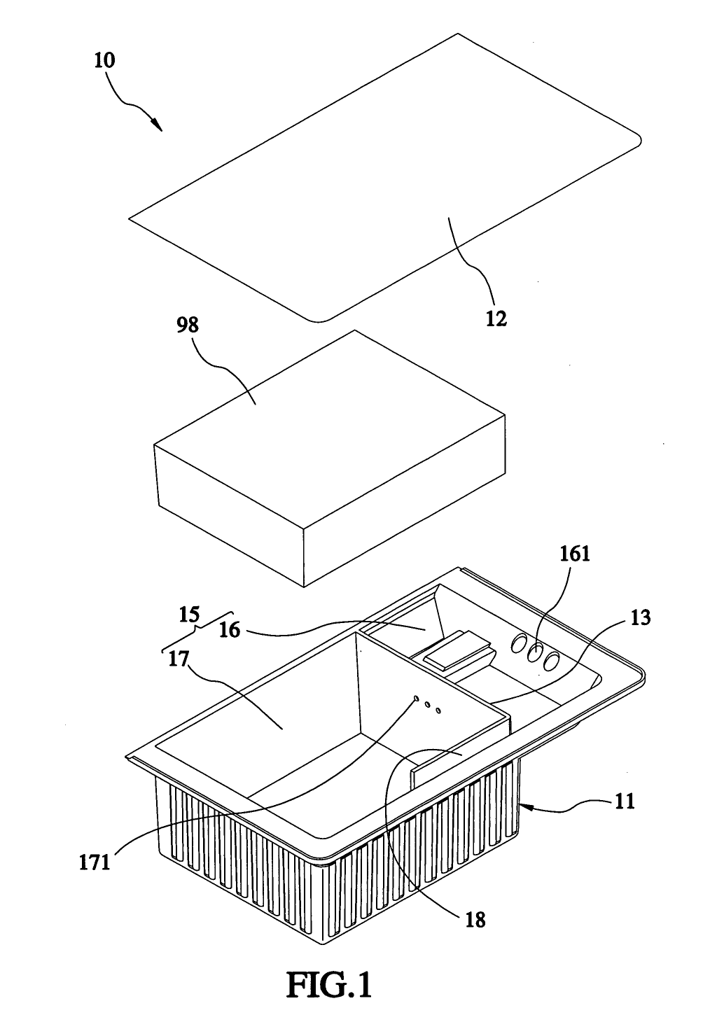

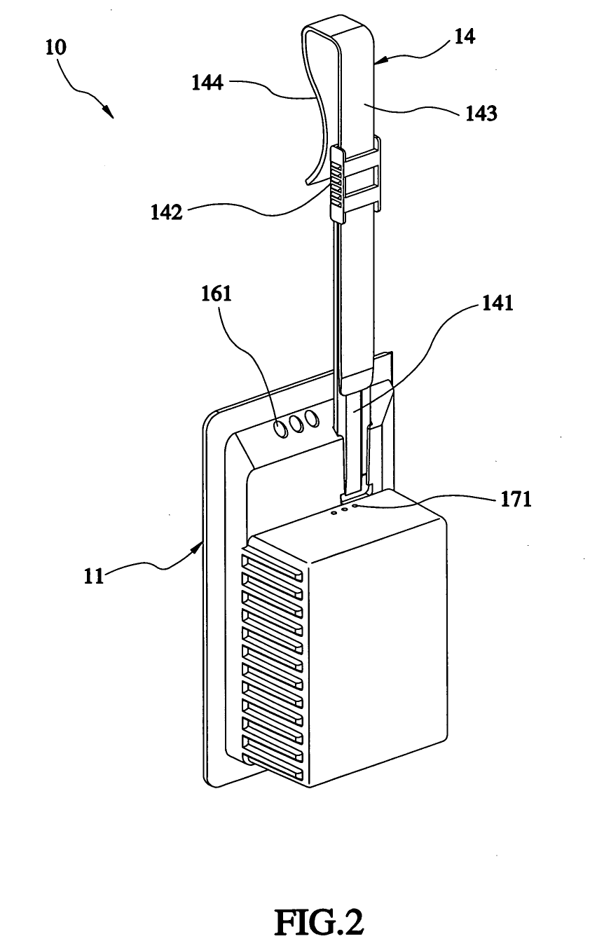

Referring to FIGS. 1-2, a toilet detergent dispenser 10 constructed according to a first preferred embodiment of the present invention is composed of a housing 11, a spacer 13, a sealing member 12, and a flow leader 18. The housing 11 includes a chamber 15 and a fixture 14 formed at an external side thereof. The spacer 13 partitions the chamber 15 into a water entrance 16 and a water exit 17. The water entrance 16 is located above the water exit 17, having at least one inlet 161 located at a top edge thereof and running through the housing 11. The water exit 17 includes at least one outlet 171 located at a top edge thereof and running through the housing 11. The inlet 161 is larger than the outlet 171 in diameter. The water exit 17 is adapted for accommodating a toilet detergent 98. The toilet detergent 98 accumulates from a front side toward a rear side of the housing 11 for a predetermined thickness. The ratio of the distance between the front and rear ends of the housing to the thickness of accumulation of the toilet detergent 98 is 2:3. Where the toilet detergent 98 is located does not cover the outlet 171. The sealing member 12 is tightly covered onto end edges of the housing 11 and the spacer 13 in such a way that the water entrance 16 and the water exit 17 are independently sealed. The flow leader 18 communicates with the water entrance 16 and the water exit 17, extending into the water exit 17 for a predetermined length. A bottom end of the flow leader 18 is spaced from a bottom edge of the water exit 17 for a predetermined distance. The fixture 14 includes a fastening part 141 and an extension part 143. The fastening part 141 has a distal end fixed to the housing 11 and an adjustment piece 142 mounted to a top end thereof. The extension part 14 has a hook 144 mounted to a top end thereof. The extension part 14 has a rear part thereof, whose length is adjustable and which is mounted inside the adjustment piece 142. The fixture 14 can be mounted to an end edge of a toilet tank 99 by the hook 144 in such a way that the toilet detergent dispenser can hung in the toilet tank 99.

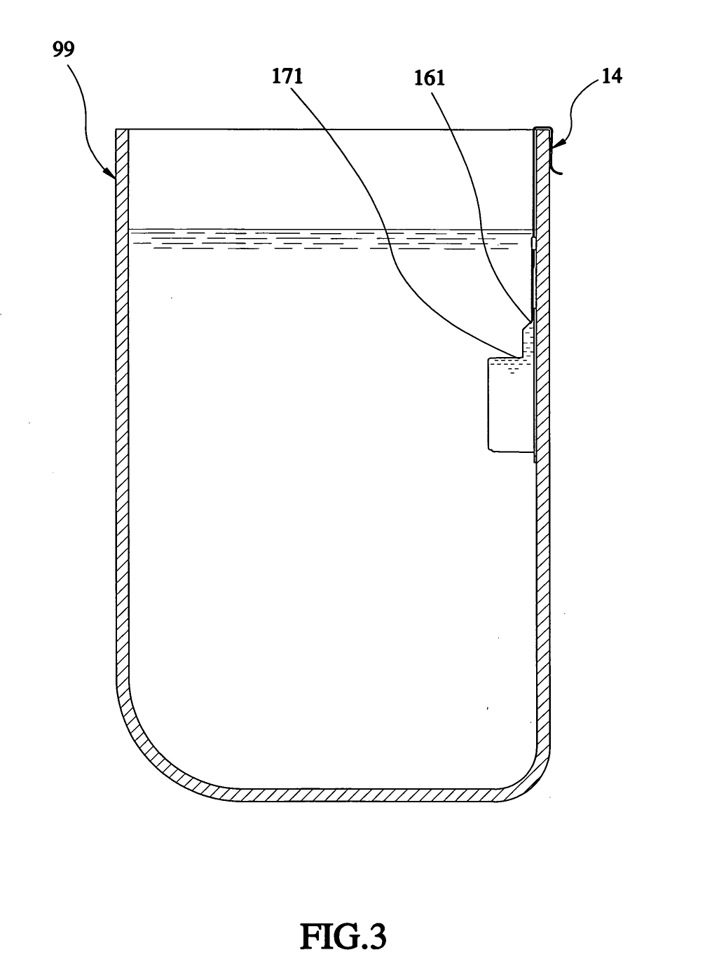

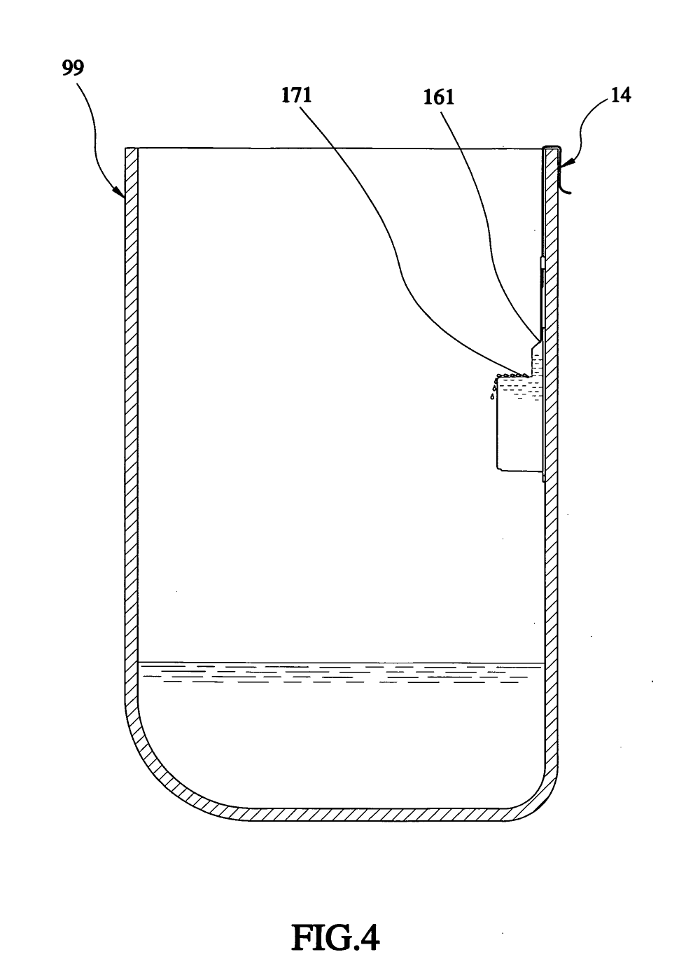

Referring to FIGS. 3-4, when the user intends to place the toilet detergent dispenser 10 of the present invention into the toilet tank 99, the user can hang the fixture 14 to an end edge of the toilet tank 99 and then properly adjust the length of the fixture 14 to enable the toilet detergent dispenser 10 to be hung to the toilet tank 99 and to sink into the water inside the toilet tank 99. In the meantime, the water inside the toilet tank 99 is infused into the water entrance 16 through the inlets 161. Next, the water flows through the flow leader 18 into the water exit 17, whereby the toilet detergent 98 is dissoluble into the water to become a saturated solution. Besides, the toilet detergent 98 does not diffuse outside the housing 11 and stops dissolution while the solution reaches saturated concentration.

When the user flushes the toilet, the water in the toilet tank 99 is flushed into the toilet in a very short time and meanwhile the water level in the toilet tank 99 lowers rapidly down to the outlet of the water tank 99. After some of the water in the toilet tank 99 exhausts, the exit of the water tank 99 is closed and then the water is refilled into the water tank 99. When the water level in the toilet tank 99 is lower than the inlet 161, the water in the water entrance 16 flows through the flow leader 18 into the water exit 17 to exhaust the saturated solution of the toilet detergent 98 through the outlet 171. The amount of the exhausted saturated solution is equal to that of the infused water from the water entrance 16. However, the outlet 171 is relatively smaller in diameter, such that the saturated solution flows outward relatively slower. Under the circumstances, when the exit of the toilet tank 99 is closed and then the toilet tank 99 is refilled with water, the outlet 171 still keeps exhausting the saturated solution of the toilet detergent 98. Before the water level rises up to the inlet 161, the saturated solution which is predetermined to be exhausted from the water exit 17 is fully released to the toilet tank 99 in time, enabling the water in the toilet tank 99 to have the predetermined ratio of the toilet detergent 98. When the water level rises up to the inlet 161, the water is infused through the inlet 161 into the water entrance 16 and then flows into the water exit 17, when the toilet is flushed next time, to exhaust the same volume of the saturated solution as the infused water.

In light of the above, the toilet detergent dispenser 10 of the present invention includes the following advantages. The toilet detergent 98 is dissolved into the water in the water exit 17 to become a saturated solution beforehand, and after the user flushes the toilet, a predetermined amount of the saturated solution is released through the outlet 171. In this way, it prevents the solution of the water and the toilet detergent 98 in the toilet tank 99 from inequable concentration and saves the consumption of the toilet detergent 98 for longer use and for cleaning purpose.

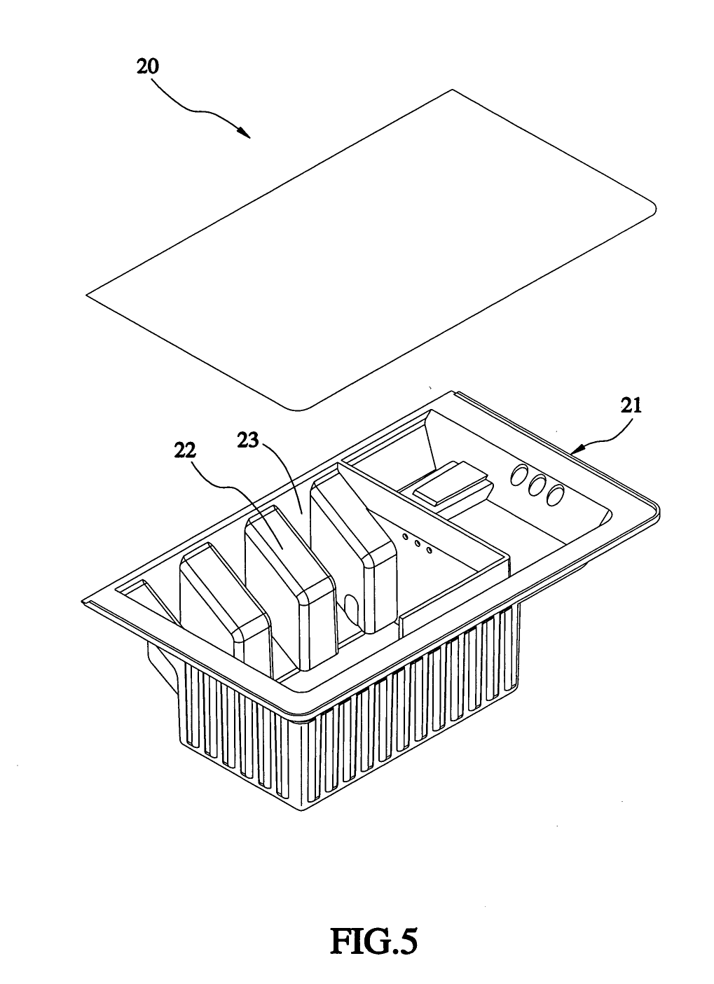

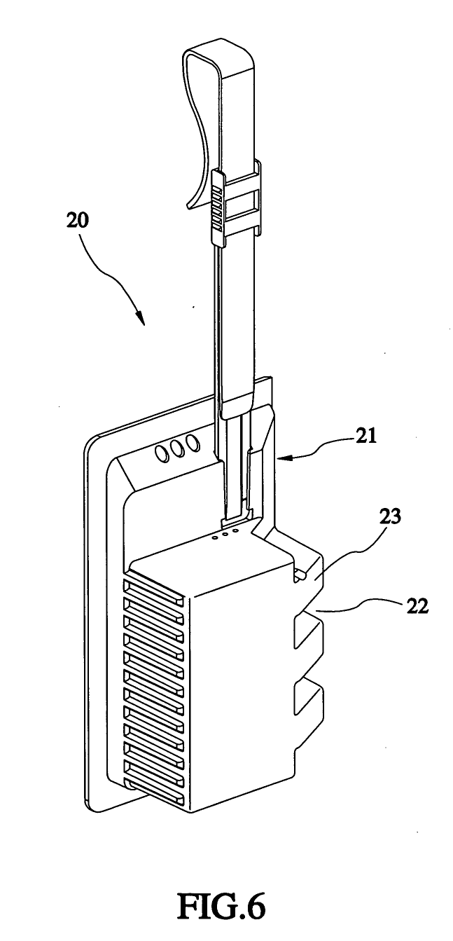

Referring to FIGS. 5-6, a toilet detergent dispenser 20 constructed according to a second preferred embodiment of the present invention is similar to that of the first embodiment, having the following difference. The housing 21 includes a plurality of concavities 22 formed at an external side thereof in a predetermined interval and a plurality of convexities 23 relatively formed between the concavities 22. In light of this, two of the toilet detergent dispensers 20 can be combined with each other by the engagement of the concavities 22 and the convexities 23 with each other.

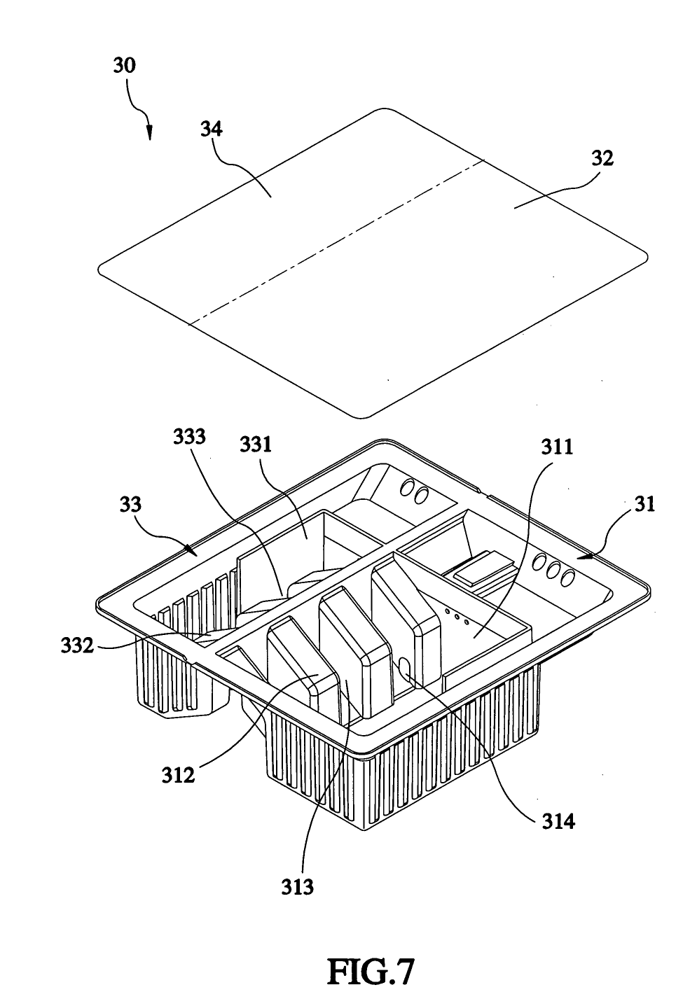

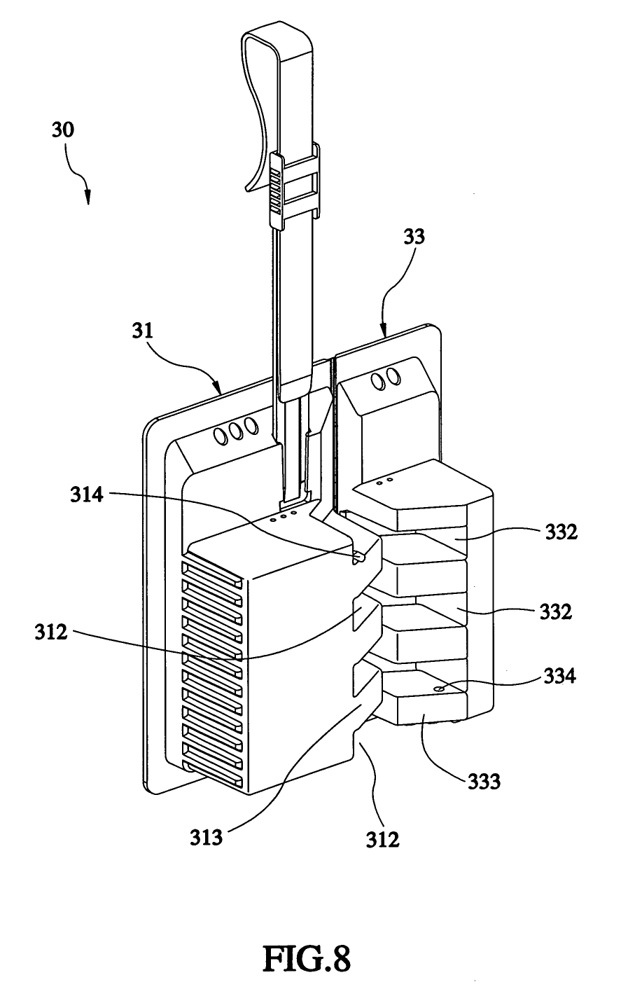

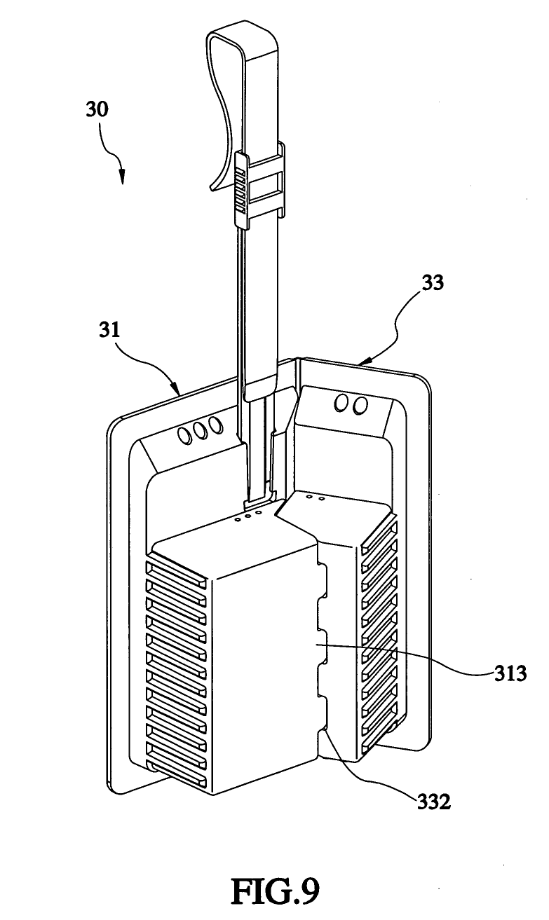

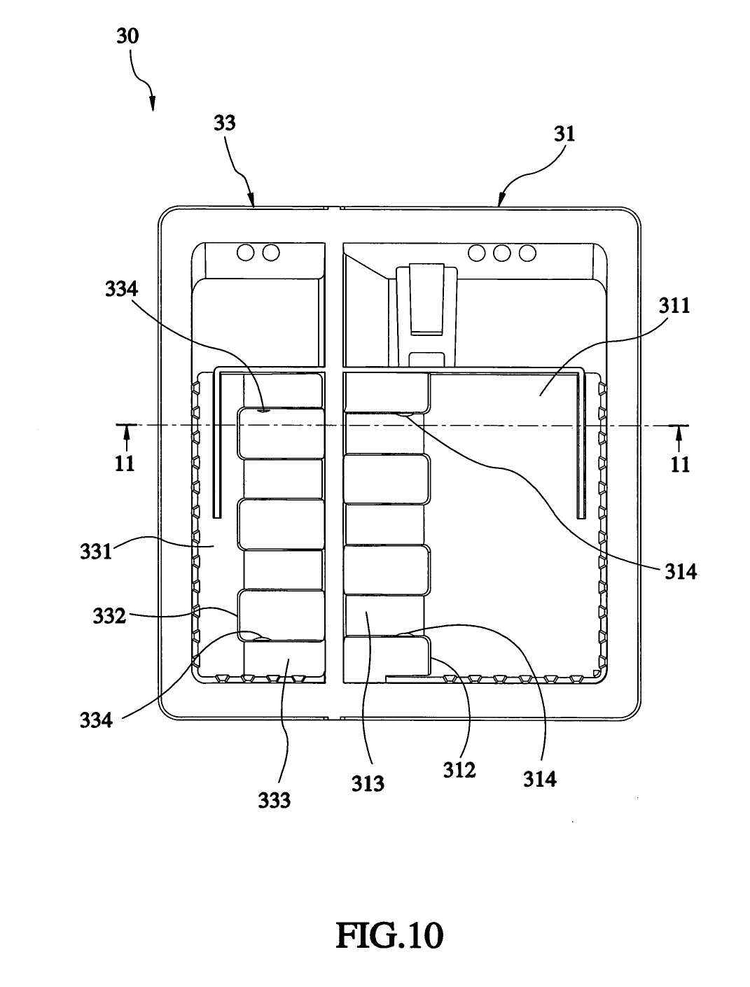

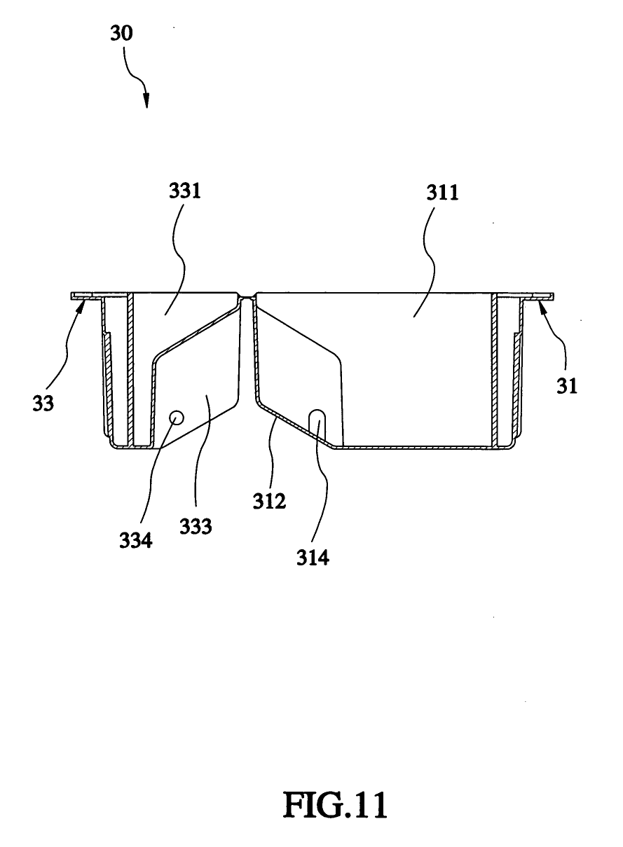

Referring to FIGS. 7-11, a toilet detergent dispenser 30 constructed according to a third preferred embodiment of the present invention similar to that of the second embodiment, having the following difference. The housing 31 includes at least one positioning convex portion 314 formed at a lateral side of the convexity 313. The toilet detergent dispenser 30 includes a sub-housing 33 and a sub-sealing member 34. A left end edge of the sub-housing 33 is connected with a right end edge of the housing 31. The sub-housing 33 has a sub-chamber 331 formed therein. The sub-housing 33 includes a plurality of sub-concavities 332 formed at a left side thereof in a predetermined interval and corresponding to the convexities 313; a plurality of sub-convexities 333 are formed between the sub-concavities 332, corresponding to concavities 312. At least one positioning concave portion 334 is formed on a lateral side of the sub-convexity 333, corresponding to the positioning convex portion 314. The concavities 312, the sub-convexities 333, the sub-concavities 332, and the convexities 313 can be engaged with one another in such a way that the housing 31 and the sub-housing 33 can be folded at a predetermined angle, and then the positioning convex portion 314 engages the positioning concave portion 334 to maintain the aforesaid angle. The sealing member 34 is tightly covered onto a rear end edge of the sub-housing 33 in such a way that the sub-chamber 331 is sealed. Accordingly, the third embodiment can likewise reach the same effects as the second embodiment.

In addition, either of the housing 31 and the sub-housing 33 can be filled with the toilet detergent 98 and the other can be filled with a toilet fragrance for the purpose of cleaning and aromatizing the toilet. By means of the engagement of the concavities 312 and the sub-concavities 332 with the convexities 313 and the sub-convexities 333, the space that the present invention occupies in the toilet tank 99 is saved.

Although the present invention has been described with respect to specific preferred embodiments thereof, it is no way limited to the details of the illustrated structures but changes and modifications may be made within the scope of the appended claims.

What is claimed is:

1. A toilet detergent dispenser comprising:
a housing having a chamber formed therein;
a spacer partitioning the chamber into a water entrance and a water exit, the water entrance being located above the water exit, the water entrance having at least one inlet running through the housing, the water exit having at least one outlet running through the housing;
a sealing member tightly covered onto rear end edges of the housing and the spacer, whereby the water entrance and the water exit are independently sealed; and
a flow leader communicating with the water entrance and the water exit and extending into the water exit, the flow leader having a bottom end spaced from a bottom edge of the water exit.

2. The toilet detergent dispenser as defined in claim 1, wherein the at least one inlet is mounted to a top edge of the water entrance, and the outlet is mounted to a top edge of the water exit.

3. The toilet detergent dispenser as defined in claim 1 further comprising a fixture, wherein the fixture is mounted to an external side of the housing for fastening the housing to an inside of a toilet tank.

4. The toilet detergent dispenser as defined in claim 3, wherein the fixture comprises a fastening part and an extension part, the fastening part having a distal end fixed to the housing, the fastening part having an adjustment piece mounted to a top end thereof, the extension part having a hook mounted to a top end thereof, the extension part having a rear part, whose length is adjustable and which is mounted inside the adjustment piece.

5. The toilet detergent dispenser as defined in claim 1, wherein the at least one inlet is larger than the at least one outlet in diameter.

6. The toilet detergent dispenser as defined in claim 1, wherein the water exit comprises a toilet detergent accumulating from a front side toward a rear side thereof.

7. The toilet detergent dispenser as defined in claim 6, wherein the ratio of the distance between the front and rear ends of the housing to the thickness of the accumulation of the toilet detergent is 2:3.

8. The toilet detergent dispenser as defined in claim 1, wherein the housing comprises a plurality of concavities formed at an external side in a predetermined interval, whereby a plurality of convexities are formed relatively between the concavities.

9. The toilet detergent dispenser as defined in claim 8 further comprising a sub-housing and a sub-sealing member, wherein the sub-housing has a sub-chamber formed therein and a plurality of sub-concavities formed at an external side thereof in a predetermined interval and a plurality of sub-convexities relatively formed between the sub-concavities, the sub-convexities corresponding to the concavities, the sub-concavities corresponding to the convexities, whereby the housing and the sub-housing engage each other by means of the concavities, the sub-convexities, the convexities, and the sub-concavities, the sub-sealing member being tightly covered onto a rear end edge of the sub-housing to seal the sub-chamber.

10. The toilet detergent dispenser as defined in claim 9, wherein the housing comprises a right end edge connected with a left end edge of the sub-housing.

11. The toilet detergent dispenser as defined in claim 9, wherein the convexities comprises at least one positioning convex portion formed at a lateral side thereof; the sub-convexities comprises at least one positioning concave portion, the positioning convex portion corresponding to the positioning concave portion.
